(19) United States
(12) Patent Application Publication
(10) Pub. No.: US 2019/0224649 A1
(43) Pub. Date: Jul. 25, 2019

(54) CATALYST FOR REDUCTION OF NITROGEN OXIDES

(71) Applicant: UMICORE AG & CO. KG, Hanau-Wolfgang (DE)

(72) Inventors: Michael SCHIFFER, Hanau (DE); Ruediger HOYER, Alzenau-Hoerstein (DE); Thomas UTSCHIG, Frankfurt am Main (DE); Franz DORNHAUS, Kobe, Hyogo (JP); Anke WOERZ, Frankfurt (DE)

(73) Assignee: UMICORE AG & CO. KG, Hanau-Wolfgang (DE)

(21) Appl. No.: 16/316,210

(22) PCT Filed: Jul. 31, 2017
(86) PCT No.: PCT/EP2017/069261

§ 371 Date: Jan. 8, 2019

(30) Foreign Application Priority Data
Jul. 29, 2016 (EP) 16182029.5

(51) Int. Cl. B01J 23/63; F01N 3/035; B01J 23/46; B01J 35/00; B01J 35/04; F01N 3/08

(52) U.S. Cl. CPC B01J 23/63; F01N 3/035; B01J 23/464; B01J 35/0006; B01J 35/04; F01N 3/0814; B01J 21/04; F01N 2330/06; F01N 2330/18; B01J 2523/822; B01J 2523/824; B01J 2523/828; F01N 3/0842

(57) ABSTRACT

The present invention relates to a catalyst comprising a support body A having a length L_{A} designed as a flow substrate, a support body B of length L_{B} designed as a wall-flow filter, and material zones A1, A2, B1, and B2, wherein the support body A comprises material zones A1 and A2 and the support body B comprises material zones B1 and B2, wherein material zone A1 contains a cerium oxide, an alkaline earth metal compound and/or an alkali metal compound, and also platinum and/or palladium, and material zone A2 contains cerium oxide, and also platinum and/or palladium, and is free of alkali metal and alkaline earth metal compounds, material zone B1 contains palladium supported on cerium oxide, and material zone B2 contains platinum supported on a support material.

The present invention relates to a catalyst for the reduction of nitrogen oxides contained in the exhaust gas of lean-burn combustion engines.

The exhaust gas of motor vehicles that are operated with lean-burn combustion engines, such as diesel engines, also contains, in addition to carbon monoxide (CO) and nitrogen oxides (NOx), components that result from the incomplete combustion of the fuel in the combustion chamber of the cylinder. In addition to residual hydrocarbons (HC), which are usually also predominantly present in gaseous form, these include particle emissions, also referred to as “diesel soot” or “soot particles.” These are complex agglomerates from predominantly carbonaceous particulate matter and an adhering liquid phase, which usually preponderantly consists of longer-chained hydrocarbon condensates. The liquid phase adhering to the solid components is also referred to as “Soluble Organic Fraction SOF” or “Volatile Organic Fraction VOF.”

To clean these exhaust gases, the aforementioned components must be converted to harmless compounds as completely as possible. This is only possible with the use of suitable catalysts.

Soot particles may be very effectively removed from the exhaust gas with the aid of particle filters. Wall-flow filters made from ceramic materials have especially proven themselves. These wall-flow filters are made up of a plurality of parallel channels that are formed by porous walls. The channels are alternately sealed in a gas-tight manner at one of the two ends of the filter so that first channels are formed that are open at the first side of the filter and sealed at the second side of the filter and second channels are formed that are sealed at the first side of the filter and open at the second side of the filter. The exhaust gas flowing into the first channels, for example, may leave the filter again only via the second channels and must flow through the porous walls between the first and second channels for this purpose. The particles are retained when the exhaust gas passes through the wall.

It is known that particle filters can be provided with catalytically-active coatings.

EP1820561 A1 describes, for example, the coating of a diesel particle filter having a catalyst layer which facilitates the burning off of filtered soot particles.

US2012/288427 A1 describes a particle filter which comprises a coating of two material zones. A first material zone comprises platinum and palladium in a weight ratio of 1:0 to greater than 1:1, and a second material zone comprises platinum and palladium in a weight ratio of 1:1 to 0:1.

2011/212008 likewise describes a particle filter in which an upstream zone comprises platinum, and a downstream zone comprises palladium.

In order to remove the nitrogen oxides, so-called nitrogen oxide storage catalysts are known, for which the term, “Lean NOx Trap,” or LNT, is common. Their cleaning action is based upon the fact that, in a lean-operating phase of the engine, the nitrogen oxides are stored predominantly in the form of nitrates by the storage material of the storage catalyst and are broken down again in a subsequent rich-operating phase of the engine, and the nitrogen oxides which are thereby released are converted with the reducing exhaust components in the storage catalyst to nitrogen, carbon dioxide, and water. This operating principle is described in, for example, the SAE document SAE 950809.

In particular, oxides, carbonates or hydroxides of magnesium, calcium, strontium, barium, the alkali metals, the rare-earth metals, or mixtures thereof are suitable as storage materials. Due to their basicities, these compounds are able to form nitrates with the acidic nitrogen oxides of the exhaust gas and to store them in this way. They are deposited on suitable carrier materials with as high a dispersion as possible, to create a large surface of interaction with the exhaust gas. As a rule, nitrogen oxide storage catalysts also contain precious metals such as platinum, palladium, and/or rhodium as catalytically-active components. Their task is, on the one hand, to oxidize NO to NO₂, as well as CO and HC to CO₂, under lean conditions and, on the other hand, to reduce released NO₂ to nitrogen during the rich-operating phases, in which the nitrogen oxide storage catalyst is regenerated.

Modern nitrogen oxide storage catalysts are described in, for example, EP0885650 A2, US2009/320457, WO2012/029050 A1, and W02016/020351 A1.

It is already known to combine soot particle filters and nitrogen oxide storage catalysts, For example, EP1420 149 A2 and US2008/141661 describe systems comprising a diesel particle filter and a nitrogen oxide storage catalyst arranged downstream, WO2011/110837, in contrast, describes a system comprising a nitrogen oxide storage catalyst and a diesel particle filter arranged downstream.

Moreover, it has already been proposed—for example, in EP1393069 A2, EP1433519 A1, EP2505803 A2, and US2014/322112—to coat particle filters with nitrogen oxide storage catalysts.

US2014/322112 describes a zoning of the coating of the particle filter with nitrogen oxide storage catalyst in such a way that one zone, starting from the upstream end of the particle filter, is located in the input channels, and another zone, starting from the downstream end of the particle filter, is located in the output channels. Both the loading with washcoat as well as that with precious metal is higher in the upstream zone than in the downstream zone.

Exhaust gas after-treatment systems for the pilot stage Euro 6c and subsequent legislation must operate effectively in a wide operating range with regard to temperature, exhaust gas mass flow, and nitrogen oxide mass flow, particularly with respect to particle number and nitrogen oxide reduction. However, the existing Euro 6a systems with a nitrogen oxide storage catalyst/diesel particle filter combination sometimes have too little nitrogen oxide storage capacity to effectively reduce nitrogen oxide under all operating conditions. In principle, this can of course be ensured by a larger volume of the nitrogen oxide storage catalyst. Frequently, however, there is no space available for an increase in volume.

What is needed, therefore, is a catalyst or a nitrogen oxide storage catalyst/diesel particle filter combination that has sufficient nitrogen oxide storage capacity and which can fit within the available space.

It has now been found that a passive nitrogen oxide storage function on a diesel particle filter arranged downstream of the actual nitrogen oxide storage catalyst solves this problem.

The present invention relates to a catalyst comprising a support body A having a length L_{A} designed as a flow substrate, a support body B of length L_{B} designed as a wall-flow filter, and material zones A1, A2, B1, and B2,

wherein the support body A comprises material zones A1 and A2, and the support body B comprises material zones B1 and B2,

wherein material zone A1 contains cerium oxide, an alkaline earth metal compound and/or an alkali metal compound, as well as platinum and/or palladium, and

material zone A2 contains cerium oxide as well as platinum and/or palladium, and is free of alkaline earth metal and alkali metal compounds,

material zone B1 contains palladium supported on cerium oxide, and

material zone B2 contains platinum supported on a support material.

The ratio of platinum to palladium can be the same or different in material zones A1 and A2 and, for example, amounts to 4:1 to 18:1 or 6:1 to 16:1—for example, 8:1, 10:1, 12:1, or 14:1.

Material zones A1 and A2 may contain rhodium as further precious metal, independently of one another. In these cases, rhodium is present, in particular, in quantities of 0.003 to 0.35 g/L. (corresponding to 0.1 to 10 g/ft³), in relation to the volume of support body A.

The precious metals platinum and palladium and, if appropriate, rhodium are usually present in material zones A1 and A2 on suitable support materials. All materials that are familiar to the person skilled in the art for this purpose are considered as support materials. Such materials have a BET surface of 30 to 250 m²/g—preferably, of 100 to 200 m²/g (determined according to DIN 66132)—and are, in particular, aluminum oxide, silicon oxide, magnesium oxide, titanium oxide, cerium oxide, and mixtures or mixed oxides of at least two of these materials.

Aluminum oxide, magnesium/aluminum mixed oxides, and aluminum/silicon mixed oxides are preferred. If aluminum oxide is used, it is, particularly preferably, stabilized, e.g., with 1 to 6 wt %—particularly, 4 wt %—lanthanum oxide.

It is preferable for the precious metals, platinum, palladium, and rhodium, to be supported only on one or more of the aforementioned support materials, and thereby not come into close contact with all components of the respective material zone.

As alkaline earth metal compound, material zone A1 comprises, in particular, oxides, carbonates and/or hydroxides of magnesium, strontium, and/or barium—especially, magnesium oxide, barium oxide, and/or strontium oxide.

As alkali metal compound, material zone A1 comprises, in particular, oxides, carbonates and/or hydroxides of lithium, potassium, and/or sodium.

The alkaline earth metal or alkali metal compound is preferably present in amounts of 10 to 50 g/L—particularly, 15 to 20 g/L—calculated as alkaline earth metal or alkali metal oxide, in relation to the volume of support body A.

Material zones A1 and A2 are present on support body A, in particular, in quantities of up to 240 g/L, e.g., 100 to 240 g/L, calculated as the sum of material zones A1 and A2 and in relation to the volume of support body A.

The cerium oxide used in material zones A1 and A2 can be of a commercially available quality, i.e., have a cerium oxide content of 90 to 100 wt %. In embodiments, material zones A1 and A2 do not comprise cerium-zirconium mixed oxides.

In a first embodiment of the present invention, the ratio of cerium oxide in material zone A2 to cerium oxide in material zone A1, calculated respectively in g/L and in relation to the volume of support body A, is 1:2 to 3:1. The sum of cerium oxide in material zone A1 and material zone A2, calculated in g/L and in relation to the volume of support body A, is, in particular, 100 to 240 g/L.

In a second embodiment of the present invention, material zone A1 comprises cerium oxide in an amount of 110 to 180 g/L in relation to the volume of support body A, wherein
the ratio of cerium oxide in material zone A1 to cerium oxide in material zone A2, calculated respectively in g/L, in relation to the volume of support body A, is 1:1 to 5:1,
the sum of cerium oxide in material zone A1 and material zone A2, calculated in g/L and in relation to the volume of support body A, is 132 to 240 g/L,
the ratio of Pt:Pd, respectively calculated in g/L, in relation to the volume of support body A, in material zone A1 and material zone A2 is equal and amounts to 2:1 to 20:1,
the sum of platinum and palladium, respectively calculated in g/L and in relation to the volume of support body A, in material zone A1 and material zone A2 is equal, and
the ratio of the concentrations of platinum and palladium in material zone A1 to platinum and palladium in material zone A2, respectively in relation to the total mass of the respective material zone, calculated respectively in g/L, in relation to the volume of support body A, is 1:1 to 1:5.

In the second embodiment of the present invention, cerium oxide is preferably used in material zone A1 in a quantity of 110 to 160 g/L—for example, 125 to 145 g/L. In material zone A2, cerium oxide is used in amounts of 22 to 120 g/L, e.g., 40 to 100 g/L or 45 to 65 g/L, in each case in relation to the volume of support body A.

In preferred second embodiments of the present invention, the total washcoat loading of support body A is 300 to 600 g/L, in relation to the volume of support body A. The result is that the loading with material zone A1 is 150 to 500 g/L, and the loading with material zone A2 is 50 to 300 g/L, in each case in relation to the volume of the first support body A. In further second embodiments of the present invention, the loading with material zone A1 is 250 to 300 g/L, and, with material zone A2, 50 to 150 g/L, in each case in relation to the volume of support body A.

In a third embodiment of the present invention, material zone A2 is present in an amount of 50 to 200 g/L, in relation to the volume of support body A, and the minimum mass fraction in % of cerium oxide in material zone A2 is calculated from the formula

0.1×amount of material zone B1 in g/L+30.

Material zones A1 and A2 can be arranged on support body A in various ways.

In a fourth embodiment, material zone A1 lies directly on support body A—in particular, over its entire length L_{A}—while material zone A2 lies on material zone A1—in particular, likewise over the entire length L_{A}.

In a fifth embodiment, beginning from one end of support body A, material zone A1 extends to 10 to 80% of its length L_{A}, and, beginning from the other end of support body A, material zone A2 extends to 10 to 80% of its length L_{A}.

In this case, it can be that L_{A}=L_{A1}+L_{A2} applies, where L_{A1} is the length of material zone A1, and L_{A2} is the length of material zone A2. However, L_{A}<L_{A1}+L_{A2} can also apply. In this case, material zones A1 and A2 overlap. Finally, L_{A}>L_{A1}+L_{A2} can also apply if a portion of the first support body remains free of material zones A1 and A2. In the last-mentioned case, a gap remains between material zones A1 and A2, which is at least 0.5 cm long, e.g., 0.5 to 1 cm.

According to the invention, material zone B1 contains palladium supported on cerium oxide, Here, as well, the cerium oxide used can be of a commercially available quality, i.e., have a cerium oxide content of 90 to 100 wt %. In particular, the cerium oxide content is 98 to 100 wt %.

In embodiments, material zone B1 does not comprise cerium-zirconium mixed oxides.

The amount of cerium oxide in material zone B1 is, in particular, 80-120 g/L, in relation to the volume of support body B.

The amount of palladium in material zone B1 is, in particular, 0.1 to 0.35 g/L, in relation to the volume of support body B.

In addition to palladium and cerium oxide, material zone B1 can also comprise additional support materials—in fact, in particular, in amounts of up to 20 g/L, in relation to the volume of support body B.

Suitable support materials include, in particular, aluminum oxide, silicon oxide, magnesium oxide, titanium oxide, and mixtures or mixed oxides of at least two of these materials.

Aluminum oxide, magnesium/aluminum mixed oxides, and aluminum/silicon mixed oxides are preferred, If aluminum oxide is used, it is, particularly preferably, stabilized, e.g., with 1 to 6 wt %—in particular, 4 wt %—lanthanum oxide.

According to the present invention, material zone B2 contains platinum supported on a support material.

The amount of platinum in material zone B2 is, in particular, 0.1 to 0.35 g/L, and that of the support material is 70 to 100 g/L, in each case in relation to the volume of support body B. As already in material zone B1, aluminum oxide, silicon oxide, magnesium oxide, and titanium oxide, as well as mixtures or mixed oxides of at least two of these materials, are suitable as support materials, with aluminum oxide, magnesium/aluminum mixed oxides, and aluminum/silicon mixed oxides being preferred. If aluminum oxide is used, it is, particularly preferably, stabilized, e.g., with 1 to 6 wt %—particularly, 4 wt %—lanthanum oxide. Aluminum oxide is, particularly preferably, used in material zone B2.

According to the present invention, support body B is a wall-flow filter. In contrast to support body A, which is present as a flow-through substrate in which, on both ends, open channels of length L_{A} extend in parallel between both of its ends, the channels in the wall-flow filter are alternately sealed gas-tight either on the first end B_{E1} or on the second end B_{E2}. Gas entering a channel at one end can thus exit the wail-flow filter again only if it passes through the channel wall into a channel that is open on the other end. The channel walls are usually porous and, in the uncoated state, for example, have porosities of 30 to 80%—in particular, 50 to 75%. In the uncoated state, their average pore size is 5 to 30 micrometers, for example.

Generally, the pores of the wall-flow filter are so-called open pores, i.e., they have a connection to the channels. Furthermore, the pores are normally interconnected with one another. This enables easy coating of the inner pore surfaces, on the one hand, and an easy passage of the exhaust gas through the porous walls of the wall-flow filter, on the other.

Material zones B1 and B2 can be arranged on support body B in various ways. In a sixth embodiment of the present invention, both material zones B1 and B2 are present only on a part of the length L_{B} of the support body B. If L_{B1} is the length of material zone B1, and L_{B2} is the length of material zone B2, then, in particular, L_{B}=L_{B1}+L_{B2} or L_{B}>L_{B1}+L_{B2} applies. In the last-mentioned case, a gap remains between material zones B1 and B2, which is at least 0.5 cm long, e.g., 0.5 to 1 cm.

In these embodiments, material zones B1 and B2 are located, in particular, within the porous walls of support body B.

In a seventh embodiment of the present invention, material zone B1 extends over the entire length L_{B} of support body B and is located in its porous walls. In this case, material zone B2 is located, in particular, on the porous walls of support body B, and, in fact, within the channels which are sealed gas-tight at the first end B_{E1} of support body B.

In an eighth embodiment of the present invention, support body B follows support body A in the downstream direction. In other words, support body A is arranged on the inflow side, and support body B is arranged on the outflow side.

The application of the catalytically-active material zones A1, A2, B1, and B2 to support body A or support body B occurs with the help of appropriate coating suspensions (washcoats) in accordance with the customary dip coating methods or pump-and-suck coating methods with subsequent thermal post-treatment (calcination and, possibly, reduction using forming gas or hydrogen). These methods are sufficiently known from the prior art.

In addition, the person skilled in the art knows that, in the case of wall-flow filters, their average pore size and the average particle size of the particles contained in the coating suspensions for producing material zones B1 and B2 can be adapted to each other such that material zones B1 and/or B2 lie on the porous walls that form the channels of the wall-flow filter (on-wall coating). Alternatively, they can be selected such that material zones B1 and B2 are located within the porous walls that form the channels of the wall-flow filter, such that a coating of the inner pore surfaces occurs (in-wall coating). In this instance, the average particle size must be small enough to penetrate into the pores of the wall-flow filter.

The flow-through substrates and wall-flow filters that can be used according to the present invention are known and obtainable on the market. They consist, for example, of silicon carbide, aluminum titanate, or cordierite.

The catalysts according to the invention are outstandingly suitable for the conversion of NOₓ in exhaust gases of motor vehicles that are operated with lean-burn engines, such as diesel engines. They achieve a good NOx conversion at temperatures of approx. 200 to 450° C., without the NOx conversion being negatively affected at high temperatures. The nitrogen oxide storage catalysts according to the invention are thus suitable for Euro 6 applications.

The present invention thus also relates to a method for converting NOx in exhaust gases of motor vehicles that are operated with lean-burn engines, such as diesel engines, which method is characterized in that the exhaust gas is guided over a catalyst according to the present invention.

In doing so, this is preferably arranged such that the exhaust gas is first guided through support body A and thereafter through support body B.

### EXAMPLE 1

a) To produce a catalyst according to the invention, a commercially available honeycomb flow ceramic support is coated with a first material zone A1 which contains Pt, Pd, and Rh supported on a lanthanum-stabilized alumina, cerium oxide in an amount of 125 g/L, as well as 20 g/L barium oxide and 15 g/L magnesium oxide. In this case, the loading of Pt and Pd amounts to 1.766 g/L (50 g/cft) and 0.177 g/L (5 g/cft), and the total loading of the washcoat layer is 300 g/L in relation to the volume of the ceramic support.

b) An additional material zone A2, which also contains Pt and Pd, as well as Rh supported on a lanthanum-stabilized alumina, is applied to the first material zone A1 The loading of Pt, Pd, and Rh in this washcoat layer is 1.766 g/L (50 g/cft), 0.177 g/L (5 g/cft), and 0,177 g/L (5 g/cft). Material zone A2 additionally contains 55 g/L cerium oxide in the case of a washcoat loading of layer B of 101 g/L.

c) In the next step, a commercially available wall-flow filter made of cordierite is coated such that material zones B1 and B2 are both located within the porous wall between the channels. However, both material zones are coated only over 50% of the length of the wall-flow filter, viz., material zone B1, starting from one end of the wall-flow filter, and material zone B2, starting from the other end.

Material zone B1 consists of 1.11 g/L (3 g/ft³) palladium on 80 g/L cerium oxide and 20 g/L aluminum oxide, while material zone B2 consists of 1.11 g/L (3 g/ft³) platinum on 70 g/L aluminum oxide.

d) The coated flow-through ceramic support according to (a) and (b) and the wall-flow filter according to (c) are combined such that, during operation, the flow-through ceramic support is arranged upstream, and the wall-flow filter is arranged downstream.

It is to be noted that the exhaust gas enters the flow-through ceramic support in such a way that it first comes into contact with material zone A2.

It is further to be noted that the exhaust gas enters the wall-flow filter in such a way that it first comes into contact with material zone B1.

1. Catalyst comprising a support body A having a length L_{A} designed as a flow substrate, a support body B of length L_{B} designed as a wall-flow filter, and material zones A1, A2, B1, and B2,
wherein the support body A comprises material zones A1 and A2, and the support body B comprises material zones B1 and B2,
wherein material zone A1 contains cerium oxide, an alkaline earth metal compound and/or an alkali metal compound, as well as platinum and/or palladium, and
material zone A2 contains cerium oxide as well as platinum and/or palladium, and is free of alkaline earth metal and alkali metal compounds,
material zone B1 contains palladium supported on cerium oxide, and
material zone B2 contains platinum supported on a support material.

2. Catalyst according to claim 1, wherein the ratio of platinum to palladium in material zones A1 and A2 is the same or different and is 4:1 to 18:1.

3. Catalyst according to claim 1, wherein material zones A1 and A2 contain rhodium, independently of one another.

4. Catalyst according to claim 1, wherein the alkaline earth metal compound in material zone A1 comprises oxides, carbonates or hydroxides of magnesium, strontium, and/or barium.

5. Catalyst according to claim 1, wherein the alkali metal compound in material zone A1 comprises oxides, carbonates or hydroxides of lithium, potassium, and/or sodium,

6. Catalyst according to claim 1, wherein the alkaline earth metal or alkali metal compound is present in quantities of 10 to 50 g/L, calculated as alkaline earth metal or alkali metal oxide and in relation to the volume of support body A.

7. Catalyst according to claim 1, wherein the ratio of cerium oxide in material zone A2 to cerium oxide in material zone A1, calculated in each case in g/L and in relation to the volume of support body A, is 1:2 to 3:1.

8. Catalyst according to claim 1, wherein material zone A1 comprises cerium oxide in amounts of 110 to 180 g/L, in relation to the volume of support body A, wherein
the ratio of cerium oxide in material zone A1 to cerium oxide in material zone A2, calculated respectively in g/L, in relation to the volume of support body A, is 1:1 to 5:1,
the sum of cerium oxide in material zone A1 and material zone A2, calculated in g/L and in relation to the volume of support body A, is 132 to 240 g/L,
the ratio of Pt:Pd, respectively calculated in g/L, in relation to the volume of support body A, in material zone A1 and material zone A2, is equal and amounts to 2:1 to 20:1,
the sum of platinum and palladium, respectively calculated in g/L and in relation to the volume of support body A, in material zone A1 and material zone A2 is equal, and
the ratio of the concentrations of platinum and palladium in material zone A1 to platinum and palladium in material zone A2, respectively in relation to the total mass of the respective material zone, calculated respectively in g/L, in relation to the volume of support body 1 is 1:1 to 1:5.

9. Catalyst according to claim 1, wherein material zone A2 is present in an amount of 50 to 200 g/L, in relation to the volume of support body A, and the minimum mass fraction in % of cerium oxide in material zone A2 is calculated from the formula
0.1×amount of material zone B1 in g/L+30.

10. Catalyst according to claim 1, wherein material zone A1 lies directly on support body A over its entire length L_{A}, and material zone A2 lies over the entire length L_{A} on material zone A1.

11. Catalyst according to claim 1, wherein material zone A1, starting from one end of support body A, extends to 10 to 80% of its length L_{A}, and material zone A2, starting from the other end of the support body A, extends to 10 to 80% of its length L_{A}.

12. Catalyst according to claim 11, wherein
L_{A}=L_{A1}+L_{A2} or
L_{A}<L_{A1}+L_{A2} or
L_{A}>L_{A1}+L_{A2}
applies, where L_{A} is the length of support body A, L_{A1} is the length of material zone A1, and LA2 is the length of material zone A2.

13. Catalyst according to claim 1, wherein both material zones B1 and B2 are present only on one part of the length L_{B} of support body B.

14. Catalyst according to claim 13, wherein
L_{B}=L_{B1}+L_{B2} or
L_{B}>L_{B1}+L_{B2}
applies, where L_{B} is the length of support body B, L_{B1} is the length of material zone B1, and L_{B2} is the length of material zone B2.

15. Catalyst according to claim 13, wherein material zones B1 and B2 are located within the porous walls of support body B.

16. Catalyst according to claim 1, material zone B1 extends along the entire length L_{B} of support body B and is located within its porous wails.

17. Catalyst according to claim 16, wherein material zone B2 is located on the porous walls of support body B in the channels, which are sealed gas-tight on the first end B_{E1} of support body B.

18. Catalyst according to claim 17, wherein support body A is arranged upstream, and support body B is arranged downstream.

19. Method for converting NOₓ in exhaust gases of motor vehicles that are operated with lean-burn engines, wherein the exhaust gas is guided over a catalyst according to claim 1.

20. Method according to claim 19, wherein the exhaust gas is first guided through support body A and thereafter through support body B.
